(19) United States
(12) Patent Application Publication
(10) Pub. No.: US 2007/0150448 A1
(43) Pub. Date: Jun. 28, 2007

(54) Method and apparatus for optimizing large data set retrieval

(75) Inventor: Michael L. Patnode, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Centrify Corporation

(21) Appl. No.: 11/319,344

(22) Filed: Dec. 27, 2005

(51) Int. Cl. G06F 17/30

(52) U.S. Cl. 707/3

(57) ABSTRACT

A method of detecting when an application running on a UNIX computer requests information from a data server, of retrieving from the data server the minimum amount of information required by the application, and of ensuring that the application gets full group information if the application requires it. Other embodiments are also described.

### BRIEF DESCRIPTION OF THE INVENTION

Embodiments of this invention work with computers running UNIX (or a variation of UNIX) and a data server (such as a directory server) within a network of computers. An embodiment of the invention on each UNIX computer detects if an application running on that computer requests a large data set from the data server. It determines the data requirements of the requesting application. If the application is likely to require only a subset of the full data set stored on the data server, an embodiment of the invention modifies the request to return only that subset of the data. If the application requires the full data set, embodiments ensure that the application gets full information.

### BACKGROUND

Applications running on a UNIX computer within a computer network often request information from a data server. That information may be stored within a large data set on the server. An application typically makes such a request by executing a function within an Application Programming Interface (API) available on the UNIX computer. When the function executes, it contacts the data server and requests data. When the server returns data, the function passes that data on to the requesting application.

API functions to retrieve only a portion of the data in a data set are not always available. Often, the functions retrieve all the data in a data set even if the requesting application does not need all the data. When the data set is large and most of the data is not needed, the request wastes time, network resources, and computer resources such as memory used to store the returned data.

As an example, the UNIX operating system defines one or more groups of users operating on a host computer or network. Each group definition is a data set that contains at minimum this set of data elements: a name for the group, a group identification number (GID), and a list of the users who are members of the group. Group definitions may be stored on a UNIX host computer, but in a network of computers they are typically stored on a central identity resolver, a type of data server such as a Lightweight Directory Access Protocol (LDAP) server or a Network Information Service (NIS) server.

Applications running on a UNIX host computer often request information about a group. An application may, for example, request the GID that corresponds to a group name, or request a list of the users that belong to a group specified by a GID or group name.

When group information is stored on a central identity resolver, applications typically request group information from the identity resolver by using a naming service such as the Name Service Switch (NSS) that is resident on the UNIX host computer. The naming service knows the network location of the identity resolver and how to request information from the resolver. Applications do not need to know anything other than how to request service from the naming service. When the naming service receives a request from the application, it contacts the identity resolver, retrieves the required information, and returns that information to the requesting application.

A naming service such as NSS contains customizable modules that define how the service retrieves information for incoming requests from applications. A customizable module may define, among other things, the identity resolver to contact for information, how to request information from the identity resolver, and how to return information to the requesting application. When a module like this is in place on a UNIX host computer, it changes the naming service's standard behavior.

A naming service typically offers an Application Programming Interface (API) for applications running on a UNIX host computer. The API contains functions that request information from the naming service. A UNIX application can use these commands to request information. NSS, for example, offers the functions getgrnam, getgrgid, and getgrent to request information about groups.

Whenever an application executes one of these API functions; the function returns a full group definition that includes a list of a group's member users. UNIX groups within a network can be quite large with hundreds, thousands, tens of thousands, or even hundreds of thousands of users. Retrieving this information may require significant network resources and computing power.

Applications often do not require the full contents of a group definition. If so, retrieving all group information wastes network resources and computing power. For example, many applications simply need to retrieve a GID that corresponds to a group name, or a group name that responds to a GID. They never need a list of a group's member users. These applications may use the NSS function getgrgid to get a GID that corresponds to a group name. If so, they receive a full list of the member users as well.

Retrieving group information from an identity resolver is not the only case where applications retrieve more data than necessary from a data set stored on a central data server. Other examples include application retrieving Network Information Service (NIS) maps or Public Key Infrastructure (PKI) certificate revocation lists (CRLs) from a central server.

### SUMMARY OF THE INVENTION

Embodiments of this invention provide methods of detecting when an application on a UNIX host computer requests data from a data server, of determining how much of the requested data the application actually requires, of determining if the required data is a subset of a data set available on the data server and, if it is, of returning a reduced set of data to the application that satisfies the application's data requirements.

An embodiment of this invention runs as a customizable module for a data-retrieval API on a UNIX host computer. When an application requests information through the data-retrieval API, the embodiment determines the name (or other identifier) of the application. The embodiment searches a list of applications that are known not to require full data sets from the data server. The embodiment checks the requesting application against the list to see if it does not require a full data set.

If the requesting application does not require a full data set, the embodiment of the invention retrieves only a subset of the data set from the data server. When the embodiment receives the requested subset from the data server, it passes the data back to the requesting application through the data-retrieval API.

The list of applications that an embodiment of the invention maintains may specify in detail what data each application requires or does not require within a data set, or the list may simply specify a set of applications that never require more than a limited data set.

An embodiment of this invention may run as a process on the identity resolver, receiving data requests from an embodiment of this invention running on a UNIX host computer. A corresponding embodiment on the UNIX host computer detects the identity of an application making a data request, but does not maintain a list of applications. It simply forwards the request along with the identity of the application making the request to the embodiment running on the identity resolver. The embodiment on the identity resolver maintains an application list that defines which applications do not require a full data set. It checks the requesting application against the list and, if it finds that the application does not require a full data set, returns only a subset of the data set to the embodiment on the UNIX computer, which returns the information to the requesting application through the data-retrieval API.

Another embodiment of this invention may run as a customizable module for a data-retrieval API on a UNIX host computer. It does not require a list of applications or an embodiment running on the data server. When this embodiment receives a request for data from an application, it retrieves a minimal subset of a data set from the data server. It then prepares a data set to return to the application. The prepared data set contains the retrieved data elements and placeholders for any data elements not retrieved. The application receives the partially populated data set.

This embodiment uses an exception mechanism such as a page-fault mechanism to monitor the application's use of the returned data set. If the application tries to read a data element that is replaced by a placeholder, an exception will be raised and the application's execution suspended. The embodiment traps the exception, retrieves the missing data element from the data server, and places the element in the data set (replacing the placeholder) so the application can resume processing with the previously-missing information.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows the components of a UNIX group definition.

FIG. 2 illustrates a UNIX computer containing a group data module that responds to group information requests from applications, determines the applications' group information requirements from an application list, and retrieves appropriate data from an identity resolver in accordance with one embodiment of the invention.

FIG. 3 illustrates the process that occurs when an application requests group information from a group data module that determines group information requirements from an application list in accordance with one embodiment of the invention.

FIG. 4 illustrates a UNIX computer containing a group data module that responds to group information requests from applications, passes the request and application identity to group request logic on an identity resolver, and receives group information whose content is determined by the group request logic in accordance with one embodiment of the invention.

FIG. 5 illustrates the process that occurs when an application requests group information from a group data module that receives that information from group request logic running on an identity resolver in accordance with one embodiment of the invention.

FIG. 6 illustrates a UNIX computer containing a group data module that responds to group information requests from applications, retrieves a minimum amount of group information from an identity resolver, writes the information to memory, then monitors the requesting application's attempt to read that memory in accordance with one embodiment of the invention.

FIG. 7 illustrates the process that occurs when an application requests group information from a group data module that retrieves minimal group information from an identity resolver, writes the information to memory, and monitors that memory in accordance with one embodiment of the invention.

### DETAILED DESCRIPTION OF THE INVENTION

This disclosure refers to UNIX processes and group data at several levels of abstraction. For precision and ease of reference, Applicant provides the following definitions, which will be used throughout the specification and in the claims.

UNIX is defined to be the UNIX operating system, a UNIX-like operating system, or variants of the UNIX operating system such as the Linux operating system or the Macintosh OS X operating system.

Data set is defined to be information stored on a data server that is related and often retrieved as a single unit. A data set contains one or more data elements. A group definition or a user record are each examples of a data set.

Naming service is defined to be a process running on a UNIX computer that accepts requests from UNIX applications for group data and retrieves that data from an identity resolver. Although the naming service on a UNIX computer is typically the Network Service Switch (NSS), it may have any name and retrieve group data in any of a variety of ways.

Group definition is defined as a stored record that defines a group of UNIX users. Although a group definition typically specifies a group name, a group identification number (GID), and a list of users who are members of the group, it may specify other properties of a user group.

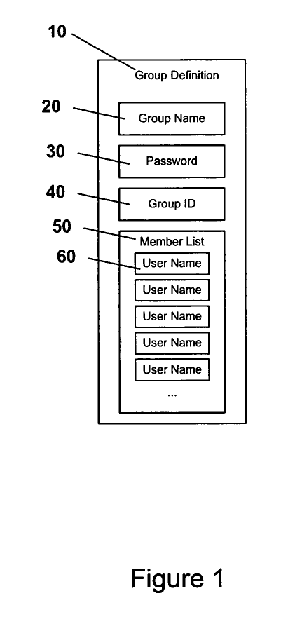

FIG. 1 illustrates the structure of a group definition (10) as it is typically defined within a UNIX network. It contains a group name (20) that is a character string that identifies the group, a password (30) that is a character string used to gain access to group features, a group ID (40) also known as a GID that is an integer that uniquely defines the group within the network, and a member list (50) that is an array of user names (60) of the users contained by the group. The list is variable in length depending on the number of users currently belonging to the group.

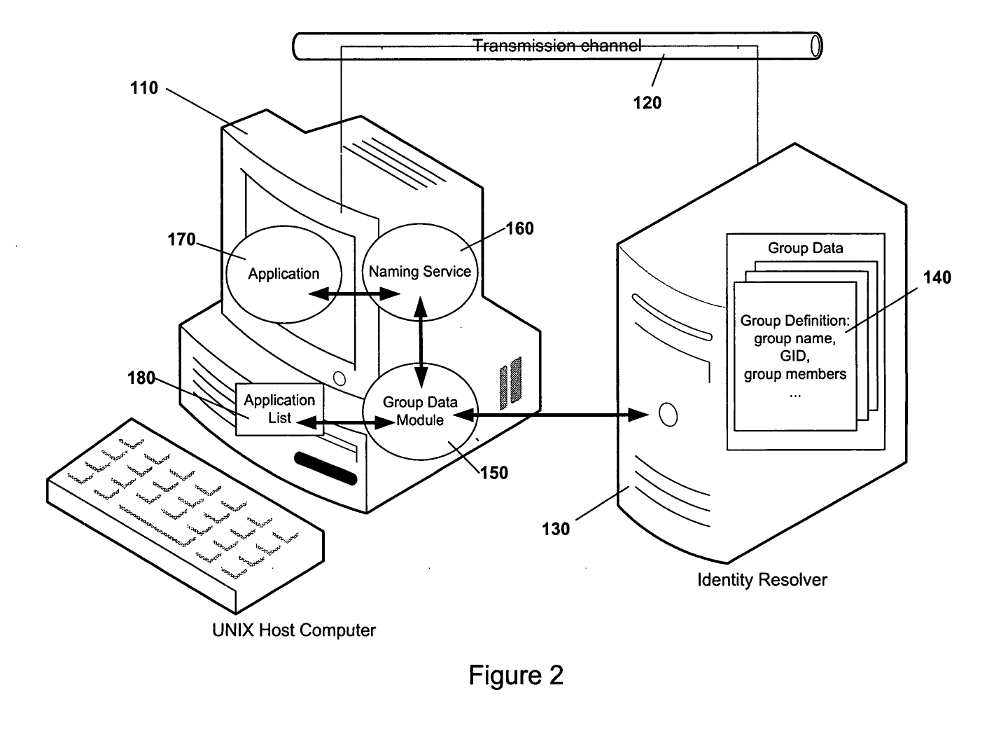

FIG. 2 illustrates a UNIX computer (110) and identity resolver (130) that may be operated in accordance with an embodiment of the invention. The computer and identity resolver are in communication through a transmission channel (120).

The identity resolver (130) can use any directory technology such as Microsoft's Active Directory, LDAP service, a relational database, or any other directory technology. The identity resolver can be a single server or a set of servers that supply unified identity resolution service to the network. The identity resolver can provide identity resolution service to one or more computers.

The identity resolver stores group data that includes one or more group definitions (140). Each group definition is a data set that typically includes a group name, a group identification number (GID), and a list of users who are members of the group.

The transmission channel (120) can be any wired or wireless transmission channel such as an Ethernet or Wi-Fi network.

The UNIX computer provides a naming service (160) that accepts requests from one or more applications (170) for information about one or more groups. The naming service in this embodiment is the Network Service Switch (NSS), but it may also be a Local Area Multicomputer (LAM) daemon or similar service. The OS-X operating system used on some Apple Macintosh computers has an information facility called “Directory Services” which provides an analogous naming service. LAM daemons and Directory Services modules can also incorporate embodiments of the invention.

The naming service may be customized to determine the way it retrieves data for requesting applications. In this embodiment, NSS works with custom modules that execute when NSS retrieves data for a requesting application. A module contains executable code that determines how NSS will retrieve data for requesting applications.

In this embodiment of the invention, a custom group data module (150) receives an application's request for group information through NSS. It also receives the identity of the application requesting the information through NSS. The module reads an application list available through the UNIX computer. That list may be a file maintained by a system administrator, or another data store available to the UNIX computer.

The application list contains the identities of applications known to have limited group information requirements. It may simply list the identities of applications that do not require a list of group members, or it may list application identities along with the group information requirements for each application.

When the group data module checks the application list, it looks for the identity of the requesting application in the list. If it finds the application there, it determines what subset of group information the application requires, then requests only that information from the identity resolver (130).

When the identity resolver returns the requested subset of group information to the group data module (150), the module passes that information to the naming service NSS (160), which returns the information to the requesting application (170).

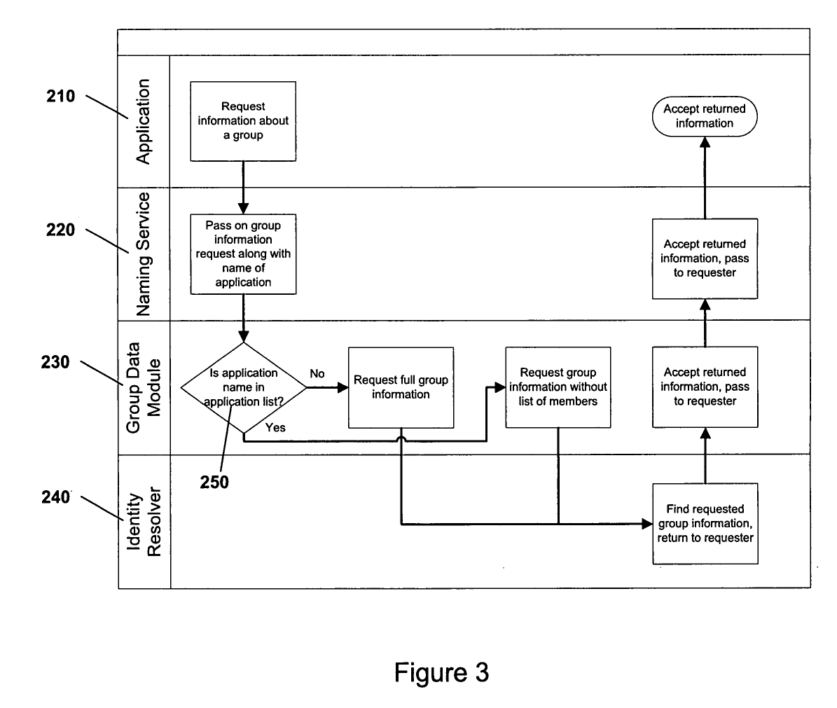

FIG. 3 illustrates the process that occurs when an application (210) on a UNIX computer requests group information from the naming service (220) on the UNIX computer. In this implementation, the naming service is NSS and it contains a custom module, the group data module (230), that is designed to determine whether a requesting application needs full group information.

When the application (210) requests group information from the naming service (220), the naming service determines the identity of the requesting application. The naming service passes the group information request and the identity of the requesting application to the group data module (230).

The group data module (230) reads an application list (250) that in this implementation is a file that contains the identities of all applications known not to require a list of group members when requesting group information. In other implementations, the application list may use other methods of specifying what applications can work with reduced group information.

The group data module (230) searches for the identity of the requesting application (210) in the application list (250). If it finds the application listed, the module requests group information without group members from the identity resolver (240). If the group data module (230) does not find the application listed, the module requests full group information from the identity resolver. This is a conservative mode of operation: if an application is not known to ignore group membership information, that (potentially large) information is retrieved from the resolver. A more aggressive mode that can reduce network traffic and processing time in more cases is described below.

The identity resolver (240) finds the requested group information within a group definition. That requested information may or may not contain group members depending on the group data module's (230) request. The identity resolver (140) returns the information.

The group data module (230) receives the group information and returns it to the naming service (220), which returns it to the requesting application.

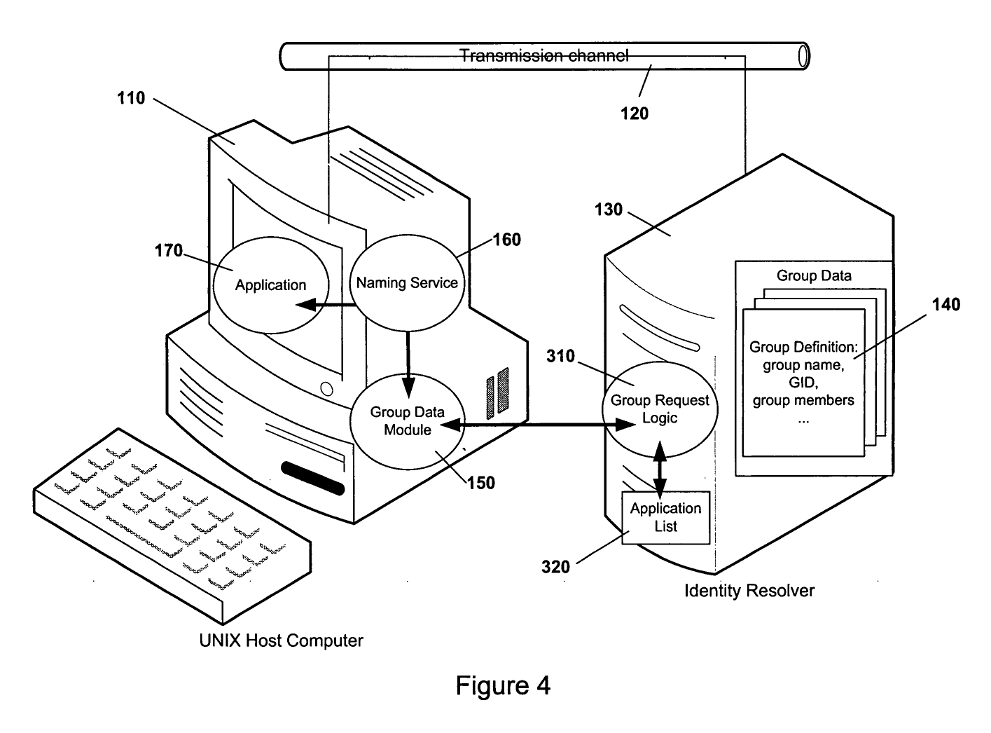

FIG. 4 illustrates a UNIX computer (110) and identity resolver (130) that may be operated in accordance with another embodiment of the invention. The computer and identity resolver are in communication through a transmission channel (120). The identity resolver and transmission channel are defined as they are for FIG. 2, and the identity resolver maintains group definitions as it does in FIG. 2.

The application list (320) in this embodiment is not consulted by the group data module on the UNIX computer, but is instead consulted by group request logic (310) running on the identity resolver (130). The list may be a file maintained by the identity resolver, or it may be some other data store available to the identity resolver. It contains information about applications and their group information requirements just as the application list (180) does in FIG. 2.

An application (170) requesting group information on a UNIX computer does so through a naming service (160) just as it does in FIG. 2. The naming service has a custom group data module (150) to which it passes group information requests just as it does in FIG. 2. In this embodiment, however, the module does not consult an application list. It simply passes the full request along with the identity of the requesting application to the group request logic (310) operating at the identity resolver. The logic then looks in the application list (320) to see if the application is listed there and, if it is, it determines what subset of group information the application requires. The logic then requests only that information from the identity resolver (130).

The identity resolver returns the requested information to the group request logic (310), which returns it to the group data module (150), which returns it to the naming service (160), which returns it to the requesting application (170).

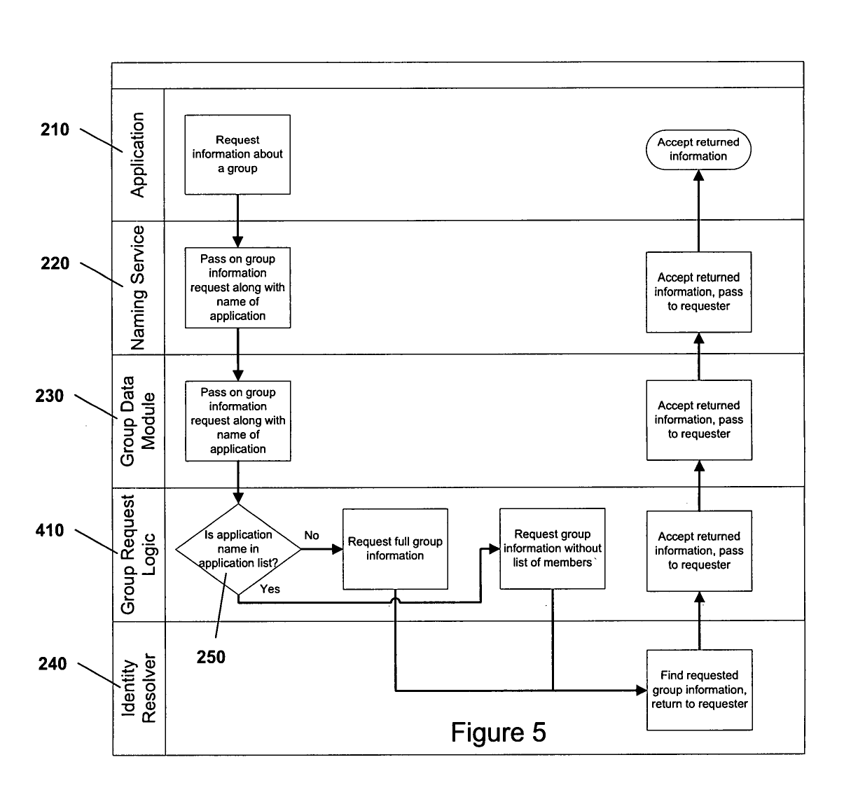

FIG. 5 illustrates the process that occurs when an application (210) on a UNIX computer requests group information from the naming service (220) on the UNIX computer. In this implementation, the naming service is NSS and it contains a custom module, the group data module (230) that simply passes group information requests along with the identity of the requesting applications to group request logic (310) that resides on the identity resolver (240).

When the application (210) requests group information from the naming service (220), the naming service determines the identity of the requesting application. The naming service passes the group information request and the identity of the requesting application to the group data module (230).

The group data module (230) passes the group information request and the identity of the requesting application to the group request logic (410). The logic reads an application list (250) that in this implementation contains the identities of all applications known not to require a list of group members when requesting group information. In other implementations, the application list may use other methods of specifying what applications can work with reduced group information.

The group request logic (410) looks for the identity of the requesting application (210) in the application list (250). If it finds the application listed, the logic requests group information without group members from the identity resolver (240). If it doesn't find the application listed, the logic requests full group information from the identity resolver.

The identity resolver (240) finds the requested group information, which may or may not contain group members depending on the group request logic's (410) request, and returns the information.

The group request logic (410) receives the group information and returns it to the group data module (230), which receives it and returns it to the naming service (220), which returns it to the requesting application (210).

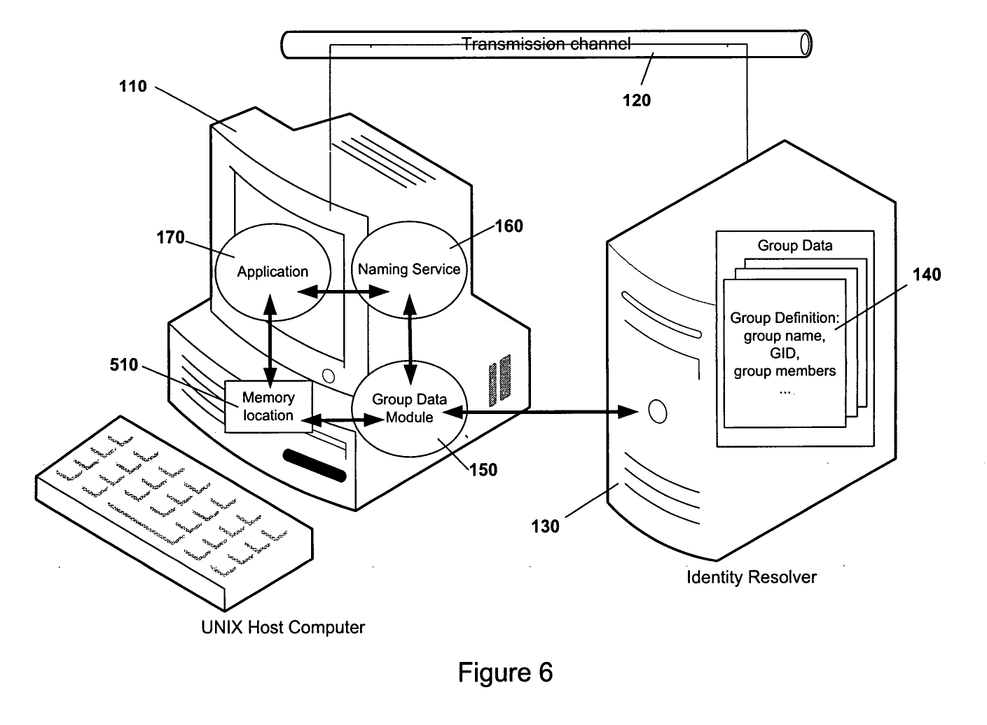

FIG. 6 illustrates a UNIX computer (110) and identity resolver (130) that may be operated in accordance with another embodiment of the invention. The computer and identity resolver are in communication through a transmission channel (120). The identity resolver and transmission channel are defined as they are for FIG. 2, and the identity resolver maintains group definitions as it does in FIG. 2.

An application (170) requests group information on a UNIX computer through a naming service (160) just as it does in FIG. 2. The naming service has a custom group data module (150) that it passes group information requests to just as it does in FIG. 2. In this embodiment, however, there is no application list. The module instead requests a minimum set of group information from the identity resolver (130) such as the group name and the group's GID.

When the group data module (150) receives the requested minimal group information, it prepares a data record in memory to return the information to the application (170). It clears memory for the record and populates it with data fields that include the retrieved information. Since only a minimal subset of the group information was requested and returned, some data fields of the record remain empty. These empty fields are filled with placeholders to indicate missing group information. For example, the group data module (150) may write a “group members” placeholder that occupies only a few bytes in memory instead of a full members list that could occupy many megabytes of memory. Each data field contains either retrieved information or a placeholder. The group data module (150) then returns a pointer to the naming service (160). The pointer provides the memory location (510) where the group information, including the placeholders, is stored. The naming service returns the pointer to the requesting application (170) so that the application can read the group information from that memory location. The application assumes that full group information is written to that memory location.

After the group data module (150) writes the group information to memory, it sets up an exception mechanism such as a page fault handler or an illegal-memory-address handler that will be invoked if the application tries to read a group information placeholder in memory (510).

When the application (170) tries to retrieve group information that is not present in memory, such as the group's member users, it tries to read the placeholder for that memory. The exception mechanism detects the attempt, interrupts the application's execution, and notifies the group data module (150). The module then requests the missing group information from the identity resolver (130), and when the information is returned, the module writes it to memory, replacing the placeholder, so the application can then read it.

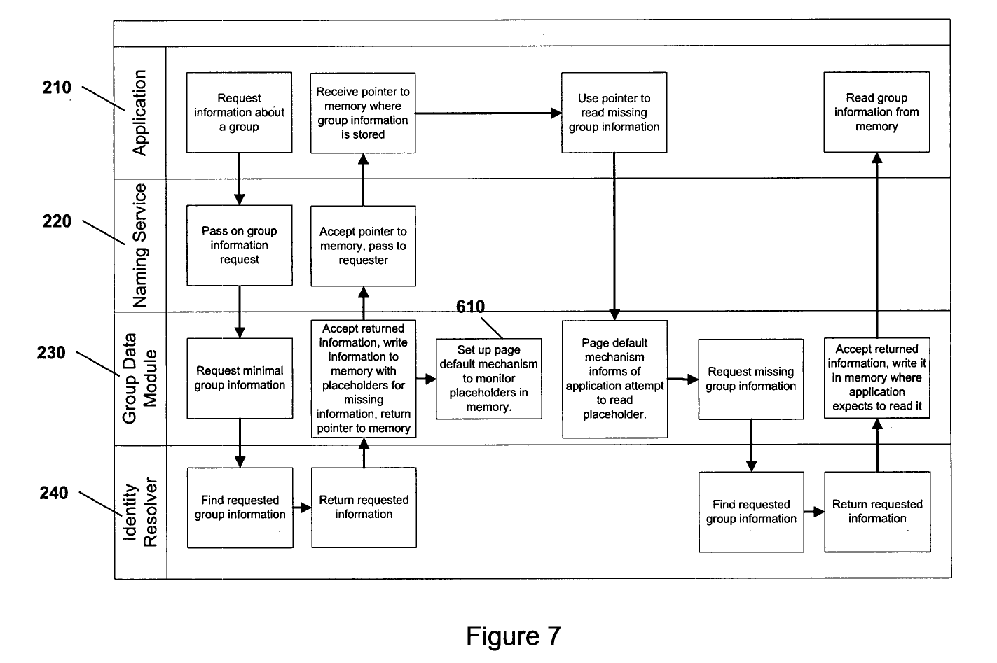

FIG. 7 illustrates the process that occurs when an application (210) on a UNIX computer requests group information from the naming service (220) on the UNIX computer. In this implementation, the naming service is NSS and it contains a custom module, the group data module (230).

When the application (210) requests group information from the naming service (220), the naming service passes the request on to the group data module (230). The module requests a minimal set of group information from the identity resolver (240), in this example just the group name and the corresponding GID. The resolver finds the group name and GID and returns them to the group data module (230).

The group data module (230) writes the group name and group ID to memory along with a small placeholder for each piece of missing group information. In this example, it writes a small placeholder for the missing group members list. The group data module then returns a pointer to that memory to the naming service. The module also sets up a page default mechanism (610) to monitor the memory where the placeholder is stored.

The naming service (220) returns the memory pointer to the application (210), which then uses the pointer to read group information from the memory location. As long as the application reads only the group name or GID, the page default mechanism (610) monitoring the memory does not notify the group data module of the application's activities. If the application (210) tries to read missing group information such as the group members list from the memory location, the page default mechanism (610) notifies the group data module (230) of the attempt.

The group data module (230) determines which placeholder (if there was more than one) the application (210) tried to read. The module then retrieves that placeholder's missing information from the identity resolver (240). When the module receives the information it writes the information to memory so the application (210) can access it.

Although all the previous examples used a group definition as the example of a data set whose data elements are partially retrieved, the principles of embodiments of the invention would work as well for many other types of data sets such as a directory user object used by Microsoft's Active Directory. A directory user object contains over 120 different types of data elements. An application requesting information about a user from the directory user object may often only be interested in retrieving the user name, just a single data element within the directory user object. Embodiments of this invention can retrieve a partial set of data elements from a directory user object and many other similar data sets.

The foregoing description of specific embodiments of the present invention are presented for purposes of illustration and description. They are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

An embodiment of the invention may be a machine-readable medium having stored thereon instructions which cause a processor to perform operations as described above. In other embodiments, the operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), not limited to Compact Disc Read-Only Memory (CD-ROMs), Read-Only Memory (ROMs), Random Access Memory (RAM), Erasable Programmable Read-Only Memory (EPROM), and a transmission over the Internet.

I claim:

1. A method comprising:
detecting if an application requests a data set from a server, the data set including a plurality of data elements;
retrieving fewer than all requested data elements of the data set from the server; and
returning the retrieved data set including at least one data element to the application.

2. The method of claim 1 further comprising:
determining an identity of the application; and
selecting the fewer than all requested data elements according to the identity.

3. The method of claim 2, further comprising:
searching a first list of application identities for the identity of the application; and, if the application identity is found on the list,
obtaining identities of the fewer than all requested data elements from a second list of elements required by the application.

4. The method of claim 1, further comprising:
populating a first group of data elements of an empty data set with data elements retrieved from the server;
populating a second group of data elements of the empty data set with placeholders; and
returning the populated data set to the application.

5. The method of claim 4 wherein the first group and the second group are mutually exclusive, and the first group and the second group together contain all the data elements of a data set.

6. The method of claim 4 wherein an access to a placeholder causes an exception, the method further comprising:
trapping the exception;
retrieving data from the server; and
replacing the placeholder with the retrieved data.

7. The method of claim 1 wherein the data set is one of a Network Information Service (“NIS”) map, a Public Key Infrastructure (“PKI”) certificate revocation list (“CRL”), and UNIX group information.

8. A machine-readable medium containing instructions that, when executed by a processor, cause the processor to perform operations comprising:
accepting a request from an application to obtain a data set from a server, the data set including a plurality of data elements;
retrieving fewer than all requested data elements of the data set from the server; and
returning the retrieved data set including at least one data element to the application.

9. The machine-readable medium of claim 8, containing additional instructions to cause the processor to perform further operations comprising:
determining an identity of the application; and
selecting the fewer than all requested data elements according to the identity.

10. The machine-readable medium of claim 9, containing additional instructions to cause the processor to perform further operations comprising:
searching a first list of application identities for the identity of the application; and, if the application identity is found on the list,
obtaining identities of the fewer than all requested data elements from a second list of elements required by the application.

11. The machine-readable medium of claim 8, containing additional instructions to cause the processor to perform further operations comprising:
populating a first group of data elements of an empty data set with data elements retrieved from the server;
populating a second group of data elements of the empty data set with placeholders; and
returning the populated data set to the application.

12. The machine-readable medium of claim 11 wherein the first group and the second group are mutually exclusive, and the first group and the second group together contain all the data elements of the data set.

13. The machine-readable medium of claim 11 wherein access to a placeholder causes an exception, the medium containing additional instructions to cause the processor to perform further operations comprising:
trapping the exception;
retrieving data from the server; and
replacing the placeholder with the retrieved data.

14. The machine-readable medium of claim 8 wherein the data set is one of a Network Information Service (“NIS”) map, a Public Key Infrastructure (“PKI”) certificate revocation list (“CRL”), and UNIX group information.

15. The machine-readable medium of claim 8 wherein the data set is UNIX group information, and the fewer than all requested data fields are elements of a group structure excluding a list of group members.

16. The machine-readable medium of claim 8 wherein the instructions are arranged as a module to be invoked from a Network Service Switch (“NSS”) controller.

17. The machine-readable medium of claim 8 wherein the instructions are arranged as a Local Area Multicomputer daemon.

18. The machine-readable medium of claim 8 wherein the instructions are arranged as a modification to Directory Services on a Macintosh OS X computing system.
